(19) United States
(12) Patent Application Publication
(10) Pub. No.: US 2014/0340014 A1
(43) Pub. Date: Nov. 20, 2014

(54) Analog Three Phase Self Excited Brushless Direct Current Motor

(71) Applicant: Westphal Daley, Hartford, CT (US)

(72) Inventor: Westphal Daley, Hartford, CT (US)

(21) Appl. No.: 13/896,904

(22) Filed: May 17, 2013

(51) Int. Cl. H02P 6/16; H02K 11/00

(52) U.S. Cl. CPC H02P 6/16; H02K 11/0073
USPC 318/400.38

(57) ABSTRACT

A brushless direct current three-phase motor that is self driven and therefore does not require externally generated waveforms for its operation. The circuit connected to the motor is analog and reduces the complexity and present cost of the driver circuitry. There is no electronic commutation of the currents in the stator coils as is the case with other brushless motors.

### BACKGROUND OF THE INVENTION

The advantages of Brushless Direct Current (BLDC) motors have been well documented over the past few decades and they have been thoroughly compared to brushed motors.

Brushed motors are comprised of field coils or field magnets, a rotor consisting of steel laminates and wire coil, a mechanical commutator, a shaft, bearings and a casing. A brushless motor is comprised of the same basic components, however its commutation is done electronically and the magnets rotate instead of the laminated core. The laminated core is the stator in a brushless motor.

Although a BLDC motor is considered superior to a brushed motor, it has at least one disadvantage. The disadvantage is the complexity of the system required to provide drive waveforms that will cause the motor to operate. This system must provide properly timed drive waveforms and commutation information to the power section of the motor. Today, almost all brushless motors have a drive system whose main component is a microchip that is proprietary to a microchip manufacturer. Clearly, when a motor is purchased, the purchaser is obligated to the microchip manufacturer. His only likely choice if something goes wrong with his expensive motor drive is to purchase a new one. Another disadvantage of BLDCs is the relatively high cost of the driver. The price makes a BLDC motor cost two to three times that of a brushed motor of similar size and power.

The microchip drive system was employed from earlier on in the development of BLDCs and it seems as if little or no research was done to make a simple analog circuit capable of efficiently driving such a motor. If a simple analog circuit were available, then a motor drive circuit could be easily constructed without the need for the complexities of the microchip and the public would not be beholden to the microchip manufacturer. At the same time, the cost of producing a motor driver could be highly reduced and there would be more flexibility in the design of a motor driver.

The main aim of this invention is to allow for simplicity and flexibility in the design of a brushless motor. This way, the cost could come down to that of a brushed motor of similar performance specifications.

Although the title of this invention includes “Self Excited”, it is understood that other self excited motors exist. They exist mainly as two phase motors used primarily for small fans such as computer board component fans. The reason those motors are not used extensively in most applications is their tendency to stall under load and their poor starting torque. A three phase motor is needed to avoid zero torque positions of the rotor. Most BLDC motors are at least three-phased, but they are digitally driven. This motor is three-phased, but its driver is all analog. Also, in this invention, there is no electronic commutation of stator currents, but the advantage of commutation is realized by the architecture of the system. This will become evident in the detailed description of this invention

Although no prior art matching this invention was found in the databases, U.S. Pat. No. 6,005,320, Kim et al is being offered as prior art because it is a self excited motor.

### SUMMARY OF THE INVENTION

Six coils of copper wire are wound around six laminated iron core stator poles and mounted on a circular motor end plate so that the poles are at equal, fixed intervals around the end plate. The center of the end plate contains a bearing through which the motor shaft enters. A circular plate with the shaft permanently affixed to its center, has four magnets affixed to it. The magnets are arranged at fixed equal intervals around the plate and their poles are arranged so that two diametrically opposite magnets have the same pole facing the stator. The other two magnets have the opposite poles facing the stator. A second end plate which is in close proximity to the plate containing the magnet, has a second bearing in its center and one side of this plate has three Hall sensors attached at fixed equal intervals of one hundred and twenty degrees around it.

The stator coils are connected in diametrically opposite pairs and each pair forms a series or parallel circuit of two coils. All energized coils produce the same electromagnetic polarity, therefore, all six coils are either North Poles or all six are South Poles, depending on the direction of motor rotation.

The plate with magnets and the shaft constitute the rotor of the motor and the shaft runs through the bearings mentioned above. A cylindrical container provides a casing for the components of the motor.

The analog drive for the motor is an electronic circuit comprised of three transistors that power the three sets of stator poles, a speed control power transistor and its driver, an analog voltage comparator, an analog potentiometer (variable resistor), a few resistors and a capacitor. The operation of this circuit and the motor in general will become apparent when the Detailed Description of this patent is studied.

### DESCRIPTION OF DRAWINGS

FIG. 1 (FIG. 1), is an expanded, transparent perspective view of the motor showing the components and their relative operating positions.

FIG. 2 is complete electronic schematic of the drive and power circuit of the motor.

### DETAILED DESCRIPTION OF THE INVENTION

The motor in this embodiment of this invention has its rotor magnets rotating axially, but the motor can be constructed to make the magnets rotate radially as well.

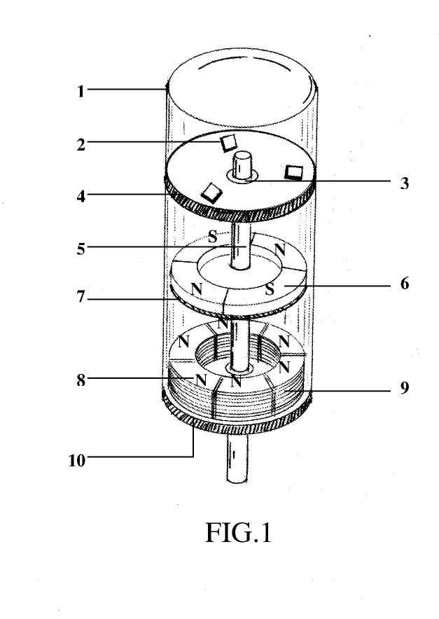

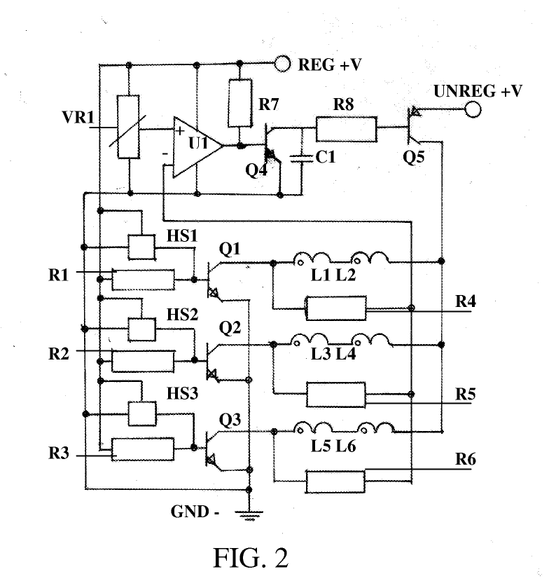

In FIG. 1, a circular end plate 10 of the motor, has six stator cores 8 made of soft iron laminates permanently attached to it. The stator cores have copper wire coils 9 wound around them and each coil has its diametrically opposite coil connected to one of its ends, so that both coils form a series or parallel circuit consisting of two coils. The coils are connected in such a way that their stator cores will have the same electromagnetic polarity when an electric current flows through them. This is shown in FIG. 2 where there are six coils designated. L1 L2, L3 L4, L5 L6 connected in series. When the motor components are assembled, the end plates fit snugly into the motor casing and therefore will not move freely.

In FIG. 1, a circular plate 7 is rigidly fixed to the motor shaft 5 and four permanent magnets 6 are affixed to this plate. The magnets are placed onto the plate with alternate polarities facing the stator cores, to which they are in close proximity. The motor shaft fits into the bearing 3 at the center of end plate 4 and also fits into the bearing in the center of end plate 10. The plate 7 is designated as the rotor, but the entire combination of this plate, the magnets and the shaft will rotate when the motor operates, so from here on, the term rotor will include these three components. The rotor is free to turn in the bearings.

The end plate 4 in FIG. 1 has three Hall sensors 2 permanently affixed to its upper surface and they are affixed so that they are one hundred and twenty degrees apart. The Hall sensors are reactive to one magnetic polarity and not the other, depending on which side of the sensor is facing the magnets and which magnetic pole is facing the sensor. Whenever the magnetic pole to which the sensor is reactive is in the immediate vicinity of the sensor, the sensor will output a signal. The signal from each sensor is fed into the drive circuit of FIG. 2 and they are used to synchronize the switching on and off of the current flowing through each stator coil pair.

A cylindrical container 1 holds the motor components in place and also serves as a cover to keep dust and other contaminants out of the motor. FIG. 1 is an expanded view of the motor and so the components might appear further apart than they are in an actual motor. In an actual motor, the distance between the top of the stator cores and the lower end of the rotor plate 7 is in the order of 0.05 inch (1.26 MM). The upper side of the magnets is around 0.1 inch (2.5 MM) from the lower side of end plate 4.

The rotor of the motor is made to rotate by switching the stator coils on at the appropriate time. This is achieved by placing Hall sensors one hundred and twenty degrees apart and adjacent to the circular path of the magnets on the rotor. In FIG. 1, any pair of stator coils can be designated as L1 L2 by the reader and the other stator coils follow in sequence. The same principle is true for the Hall sensors. In FIG. 2, when HS1 has a high output (it is not active), Q1 is turned on, and current will flow through L1 L2, causing an electromagnetic field to form around the stator cores surrounded by these two coils. This is assuming that PNP transistor Q5 is on and is supplying power to the circuit. If the stator poles have become north poles, both diametrically opposite poles will repel the magnets that are north poles and facing the stators. At the same time, they attract the magnets that have south poles and are facing the stators. This action eliminates the need for electronic commutation and also, all four magnets are interacting with at least two stator poles at all times. This is useful for reducing torque ripple.

At the point where magnetic south poles are positioned directly above L1 L2 there is zero torque, due to the attractive forces between the magnets and north poles of the stator cores. Hall sensor HS2 is switched off at this point and so L3 L4 are energized by Q2. Magnetic north poles are again repelled and magnetic south poles are attracted to the cores of L3 L4. The action continues and soon L5 and L6 are energized. When L5 and L6 have interacted, the rotor has gone through one complete cycle and Q1 is again turned on to start a new cycle

The motor needs to run as efficiently as possible and have a means for controlling its speed. The circuit of FIG. 2 provides for smooth speed control and efficient power conversion. Its operation is as follows: Electrical power is supplied as voltages between UNREG+V, REG+V and GND− (see FIG. 2). The three Hall sensors have their outputs connected to REG+V via three resistors R1, R2, R3. This makes the outputs normally high, but if a magnet is activating a sensor, that sensor's output will be low. When power is turned on, one, or two, sensors might be activated (low output). If two sensors are activated, then the third sensor will be high. Let us say that HS1 is left high when power is turned on. This high will cause NPN transistor Q1 to go low at its collector and current will flow through L1 L2 when a voltage is supplied by the collector of PNP power transistor Q5. This action causes the network of R4, R5, and R6 to go low at their point of common connection. This common point is directly connected to the inverting input of voltage comparator U1. The Non-inverting input of U1 is connected to the speed control potentiometer VR1.VR1 sets the voltage on the non-inverting input of U1. The motor will have a minimum speed at which it will operate, so VR1 can set+input of U1 to the voltage representing the lowest speed at which the motor will operate. The lowest speed setting will be such that it is always higher than the short circuit voltage across Q1, when Q1 has been turned on. This allows the motor to easily start up when power is turned on at first and a low speed is required.

Let us assume that at this instance, the speed is set to minimum. Because Q1 has been turned on by HS1, its collector goes low and because the+input of U1 is higher than the—input, the output electrode of U1 which is connected to R7 goes high. This causes current to flow through R7 into the base of NPN transistor Q4. Q4 has a capacitor C1 connected to its collector to reduce noise in the circuit. Q4's collector goes low and draws current through the base-emitter junction of PNP power transistor Q5. Q5 therefore conducts and applies voltage to the common junction of the stator coil combinations L1 L2, L3 L4, L5 L6. During this time, Q1 has been on, so current will flow through Q5, L1 L2 and Q1 to GND−. The rotor will turn because the electromagnetic fields created by the current flowing through L1 L2 cause their stator poles to interact with the magnets in their immediate vicinity. The rotor is turning slowly because the rotor will need several rotations before the motor is up to speed. The first time that Q5 supplies current, it will be the largest current it supplies. It is the largest because the reactance of the coils will be at their lowest, when the rotor is at its lowest speed. After the rotor starts turning, its inertia keeps it going and the voltage at the common point of R4 R5 R6 eventually increases. This increase in voltage occurs because as speed increases, the reactance of the coils increases, thereby reducing the current through Q1. Q1's collector voltage rises as a consequence. As Q1 collector voltage increases, U1−input goes higher than U1+input and Q5 is turned off. Because Q5 is off, there is no power to any of the three transistors Q1, Q2, Q3, so the motor slows down. It slows to a speed where the voltage at U1−input is again lower than the voltage at U1+input. Q5 is turned on again. The motor speeds up again. The cycle continues, but the voltage on U1−input can only rise to the level that will be enough to surpass the set voltage on U1+input, before the power to the output transistors Q1, Q2, Q3 will be cut off by Q5. Therefore, the speed at which the rotor will turn is limited by the voltage set by VR1. If VR1 sets a higher voltage, then U1−input needs a higher voltage from the R4, R5, R6 junction before the power to the output transistors can be shut off. This means that the motor will have to be running at a higher speed and is therefore on for a longer time than it is off. Speed control of the motor has therefore been achieved. The fact that the motor has to be on for a longer time in order to go faster, and on for a shorter time to go slower, means that power to the motor is pulse width modulated. Pulse Width Modulation is a more efficient way to power a motor.

What is claimed is:

1. An analog three phase brushless self excited direct current motor having at least four permanent magnets rigidly affixed to a circular rotor plate, the rotor plate having a shaft rigidly attached to its center so that the shaft is perpendicular to plane of the plate, the magnets being arranged on the rotor plate so that diametrically oppositely positioned magnets have the same magnetic polarity on one pair of magnets and have the opposite polarity on the other pair of diametrically opposite poles, the magnets being attached to the rotor plate so that they are close to the periphery of the rotor plate and each magnet is itself attached so that one of its poles is facing the rotor plate and the other faces open space, the magnetic poles facing the rotor plate also face the poles of at least six stator poles made of soft iron laminates that are rigidly attached to a motor end plate and have a coil of copper wire wound around each one; said stator poles being energized at appropriate times by passing through the coils, an electric current that is switched on and off by three Hall Effect sensors that are rigidly affixed to the other end plate of the motor at one hundred and twenty degree spacing; said Hall Effect sensors being used to send signals that reveal the instantaneous angular positions of the magnets to an analog electronic control unit as the rotor rotates about the shaft affixed to is center and is passing through bearings embedded in both end plates of the motor.

2. An analog three phase brushless self excited direct current motor as in claim 1, that has at least six stator poles and coils connected so that diametrically opposite coils on a circular end plate of the motor form a series or parallel circuit of two coils, making a total of at least three pairs of coils that have the same electromagnetic polarity when they are energized by an electric current.

3. An analog three phase brushless, self excited, direct current motor as in claim 1 and claim 2 that employs an analog electronic circuit consisting of three output power transistors whose collectors are connected one each to one pair of stator coils and whose bases are driven one each by one of three Hall Effect sensors that have a high output when they are not activated by the magnets on the rotating rotor plate; said high output causes said output transistors to pass current through the appropriate stator windings at the appropriate time; said output power transistors providing a feedback voltage level to the inverting input of an analog voltage comparator whose purpose is to compare this feedback voltage to a reference speed voltage on its non-inverting input and thereby deciding whether power should be applied to the output power transistors that supply current to the stator windings at specific times.
